(19) United States
(12) Patent Application Publication
(10) Pub. No.: US 2007/0138096 A1
(43) Pub. Date: Jun. 21, 2007

(54) SYSTEMS AND METHODS FOR CONTROLLING CONTAMINATE LEVELS OF PROCESSED WATER AND MAINTAINING MEMBRANES

(76) Inventors: Ronald Scott Tarr, Louisville, KY (US); Timothy Worthington, Crestwood, KY (US); Derek Lee Watkins, Elizabethtown, KY (US)

Correspondence Address: MERCHANT & GOULD PC, P.O. BOX 2903, MINNEAPOLIS, MN, 55402-0903, US

(21) Appl. No.: 11/616,924

(22) Filed: Dec. 28, 2006

Related U.S. Application Data
(63) Continuation-in-part of application No. 10/982,731, filed on Nov. 5, 2004.

(51) Int. Cl. B01D 61/00

(52) U.S. Cl. 210/650; 210/739; 210/805; 210/96.2; 210/194

(57) ABSTRACT

Systems and methods for treating water as well as maintaining water treatment systems are disclosed. The systems and methods include circulating influent water in a recirculation loop. In addition, a contaminate level may be monitored by sensors. When the contaminate level exceeds a set contaminate level, contaminates may be bleed from the systems.

### CROSS-REFERENCE TO RELATED APPLICATIONS

The present application is a Continuation-In-Part of U.S. patent application having Ser. No. 10/982,731 filed Nov. 5, 2004 which is hereby incorporated by reference in its entirety.

### FIELD OF INVENTION

Embodiments of the present invention relate to water treatment. More specifically, embodiments of the present invention relate to systems and methods for water treatment and maintaining the membranes of a reverse osmosis water treatment system.

### BACKGROUND

Pressurized reverse osmosis water treatment systems which incorporate a recirculation loop to improve efficiency are sensitive to membrane degradation and excessive contaminates in permeate (treated) water. Influent water contaminate levels can vary widely. Currently, pressurized reverse osmosis water treatment systems utilizing a recirculation loop have a fixed bleed system which sets system water efficiency. The bleed rate may be set at the factory or set in the field by a technician. The bleed rate may be based on the influent water contaminate levels at the time of installation. If the influent water chemistry changes over time, or the bleed rate is set incorrectly, the permeate water quality may be inconsistent. Moreover, improperly set bleed rates may also lead to shortened system life.

Currently systems require that a customer pay a technician to monitor and maintain their systems on a regular basis. These maintenance contracts can be costly, time consuming, and inadequate to facilitate proper system maintenance. Setting a cleaning cycle for a fixed time may result in poor system water treatment and may shorten system component life. Furthermore, if the time between the maintenance inspections is too great, contamination levels may rise without notice and may lead to premature system malfunction. There exists a need for systems and methods to combat the aforementioned problems.

### BRIEF DESCRIPTION OF THE INVENTION

In one aspect, embodiments of the present invention include a system and method of treating water is disclosed. The method includes circulating influent water in a recirculation loop. A portion of the influent water passes through at least one membrane. In one embodiment, a sensor may monitor a recirculation contaminate level in the recirculation loop. When the recirculation contaminate level exceeds a maximum contaminate level, contaminates may be bled from the recirculation loop.

In another embodiment, a sensor may monitor a permeate contaminate level after the permeate has exited the recirculation loop. When the permeate contaminate level exceeds a maximum permeate contaminate level, contaminates may be bled from the recirculation loop.

In another embodiment, the system includes a recirculation loop configured to allow a portion of influent water to pass through at least one membrane. A sensor may be configured to monitor a contaminate level within the system. Upon receiving an indication from the sensor, contaminates may be bled from the system.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1 depicts a water conditioning system;

FIG. 2 depicts the water conditioning system of FIG. 1 configured to cleanse membranes;

FIG. 3 depicts a softening membrane in a system for conditioning water; and

FIG. 4 is another embodiment showing a softening membrane in a system for conditioning water.

### GENERAL DESCRIPTION

Embodiments of the present invention utilize a sensor to monitor contaminate levels in a recirculation loop and/or permeate water. Upon receiving an indication from the sensor that contaminate levels have exceeded and/or are approaching a maximum contaminate level, contaminates in the recirculation loop may be bled from the system.

Other aspects of the invention include having the sensor monitor a cleaning cycle. The cleaning cycle includes recirculating permeate water across the membranes of a reverse osmosis water treatment system. Upon commencement of the cleaning cycle the sensor may monitor the contaminate level of the recirculation loop and/or the permeate water to determine a cleaning cycle operating time.

### DETAILED DESCRIPTION

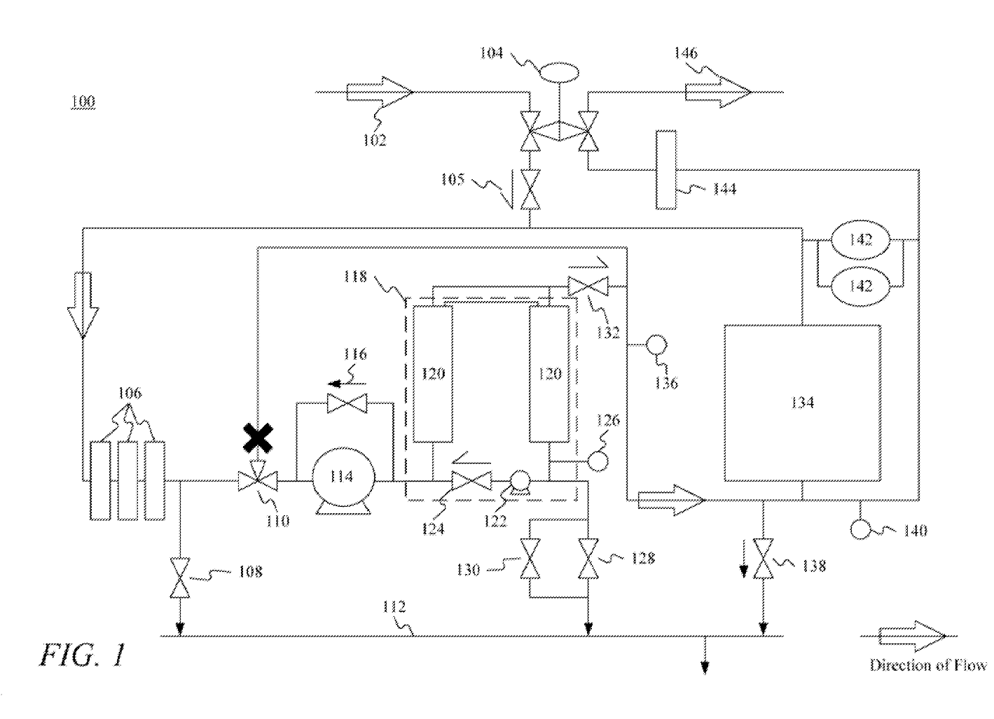

Referring now to the figures, FIG. 1 depicts a water treatment system 100. Influent water enters the system 100 at a point of entry 102. Upon entering the system 100 the influent water may bypass the treatment components of the system 100 if a bypass valve 104 is so configured. Check valve 105 acts to prevent “back flow.” When the bypass valve 104 is closed, the influent water flows through check valve 105 and may pass through filter 106. Filters 106 may be used to “prefilter” the influent water. This prefiltering stage may remove precipitants and/or other solids from the influent water.

Valve 108 may be a flush valve used to purge the system 100 upon performing maintenance on filters 106. For example, after replacing filters 106 valve 110 may be closed to restrict water from continued flow through the system 100. Valve 108 may be opened to allow flushed water to be diverted to drain 112. The flushed water may be diverted to a municipal drain or reintroduced to the system 100 at some point before filters 106 for treatment. While three prefilter filters 106 are shown, it is contemplated that any number of prefiltering filters 106, including zero, may be implemented.

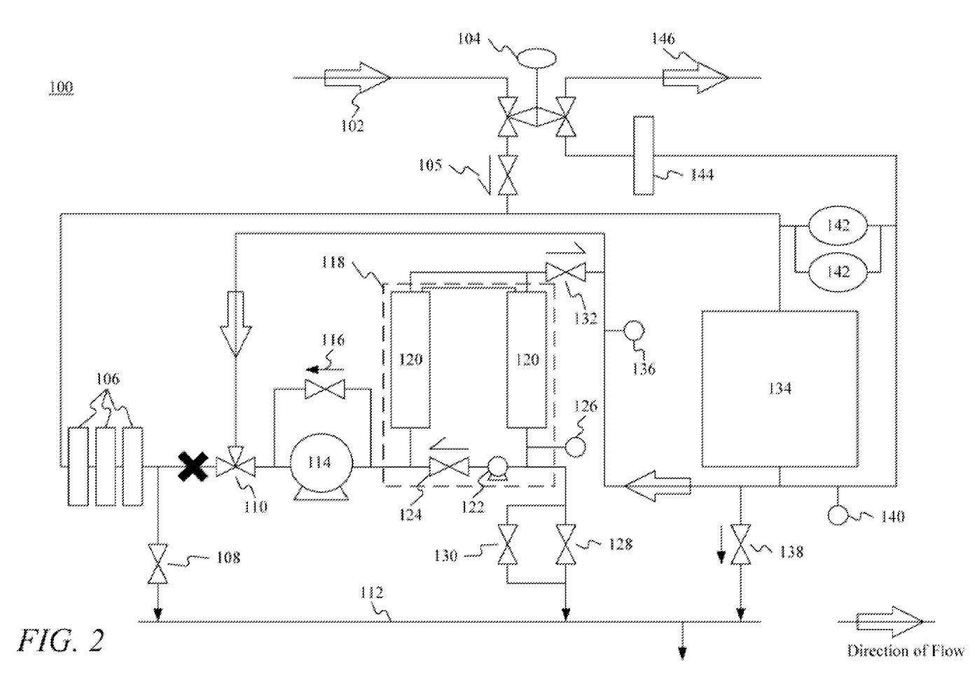

As symbolized by the “X”, valve 110 is configured to allow water from filters 106 to enter pump 114. As seen in FIG. 2, value 110, as symbolized by the “X”, may be configured to block water from filters 106 from entering pump 114. The “X” in FIGS. 1 and 2 symbolizes that water will not flow in the pipe section where the “X” is located.

Pump 114 boosts the pressure of the influent water as necessary for system operations. For example, if the inlet pressure is 1.00 ATM (14.7 psi) pump 114 may boost the pressure to 10.89 ATM (160 psi). Valve 116 is a pressure control valve. In various embodiments valve 116 may be a differential pressure control valve. Current pressurized reverse osmosis systems utilize pumps with variable speed motors and/or staged pumping systems, both of which are expensive. Valve 116 may enable pump 114 to be a fixed boost (e.g. a rotary vane pump) and become a variable boost pump by causing pump 114 to enter a race state. The race state comprises diverting a portion of the influent water from the exit of pump 114 back to the inlet of pump 114. Valve 116 creates a head loss so that the portion of the flow diverted back to the inlet has a pressure approximately equal to that of the flow exiting valve 110. While FIG. 1 shows a fixed boost pump and a pressure control valve to control the boost pressure, it is contemplated that a variable boost may be used with or without a pressure control valve.

Water leaving pump 114 enters recirculation loop 118. The direction of flow within the recirculation loop is controlled by check valve 124. While within the recirculation loop 118 pump 122 causes the water to circulate through membranes 120. While two membranes are shown in FIG. 1, it is contemplated that a single membrane or more than two membranes may be implemented within the recirculation loop 118.

In an embodiment of the present invention, sensor 126 may be located within recirculation loop 118. By placing sensor 126 in the recirculation loop 118, the contaminate level (i.e. contaminate concentration) may be monitored. Upon detecting that the contaminate level has reached a maximum contaminate level, sensor 126 may cause valve 128 to open and bleed contaminates from the recirculation loop 118. By way of example and not limitation, sensor 126 may be a total dissolved solids sensor or any other sensor able to measure contaminate levels. When the contaminate level reaches and/or goes below a minimum contaminate level, sensor 126 may partially or completely close valve 128 so as to retard or halt bleeding of contaminates from the recirculation loop 118 to drain 112. Similarly, valve 128 may be a variable flow valve that may be used in conjunction with sensor 126 to continuously bleed contaminates from the system 100. For example, valve 128 may open and close to continuously adjust the bleed rate in an attempt to maintain contaminates levels at a fixed value or within a range of values. In addition, a series of valves may also be used to reduce or increase the amount of bleed water and regulate the level of contaminates in the recirculation loop 118.

For example, a maximum contaminate level within the recirculation loop 118 of 1,500 ppm (parts per million) may be established. During operation of the system 100 valve 128 may close and the recirculation loop 118 may have a contaminate level of 1,290 ppm. As the system 100 operates the contaminate level may rise as influent water is treated. When the contaminate level within the recirculation loop reaches 1,500 ppm or some other preset level, valve 128 may open and contaminates are bled from the system. When the contaminate level drops below a previously defined threshold level, sensor 126 may signal valve 128 to partially or completely close, retarding and/or halting the bleeding of contaminates.

The system includes a valve 130 to allow for a membrane flush. A membrane flush may occur after or during maintenance of the recirculation loop 118 and comprises flushing large quantities of water or other cleaner(s) through the recirculation loop 118. For example, after replacement and/or cleaning of membranes 120, a membrane flush may be performed to remove solids or other contaminates that may have been introduced to the system 100. In addition, valve 130 may be controlled by sensor 126 to assist with contaminate bleeding.

For example, valve 128 may be sized so that the maximum flow achievable is 0.45 lpm (liters per minute) (0.1 gallons per minute) and valve 130 may have a maximum flow rate of 45.46 lpm (10.0 gpm). Should the influent water have high contaminate levels, a 0.45 lpm flush may not be enough to bring the contaminate levels within the recirculation loop 118 to within allowable tolerances. In this instance, valve 130 may be used instead of or in conjunction with valve 128 to achieve a necessary bleed rate.

Water exits the recirculation loop 118 through valve 132. Valve 132 may be a check valve or other form of back flow prevention. Valve 132 inhibits permeate water from being reintroduced into the recirculation loop 118. After exiting the recirculation loop 118, a portion of the permeate water may be stored in a storage tank 134. The stored permeate water may be used in a cleaning cycle, as described with reference to FIG. 2. Before entering the storage tank 134, a permeate water contaminate level may be monitored by sensor 136. Consistent with embodiments of the present invention, other fluids may be circulated through recirculation loop 118 to clean the membranes 120. By way of example and not limitation, the cleaning fluid may be water, a water/detergent solution, an alcohol based solution, or any other suitable solution.

Similar in concept to the monitoring contaminate levels in the recirculation loop 118, by placing sensor 136 in the flow of permeate water, the contaminate level (i.e. contaminate concentration) may be monitored. Upon detecting that the contaminate levels within the permeate water has reached a maximum level, sensor 136 may control valve 128 to bleed contaminates from the recirculation loop 118. By way of example and not limitation, sensor 136 may be a total dissolved solid sensor or any other sensor able to measure contaminate levels. When the contaminate level reaches or goes below a minimum contaminate level, sensor 136 may partially or completely close valve 128 so as to retard and/or halt bleeding of contaminates from the recirculation loop 118 to drain 112. Similarly, valve 128 may be a variable flow valve used in conjunction with sensor 136.

For example, a maximum contaminate level within the permeate water of 120 ppm may be established. During operation of the system 100 valve 128 may be closed and the permeate water may have a contaminate level of 82 ppm. As the system 100 operates the contaminate levels may rise as influent water is treated. When the contaminate level within the permeate water reaches 120 ppm or some other preset value, valve 128 may open to allow contaminates to be bled from the system. When the contaminate level of the permeate water drops below a previously defined threshold level, sensor 136 may send a signal to valve 128. Valve 128 may partially or completely close, retarding and/or halting the bleeding of contaminates.

Sensors 126 and 136 may be used separately or in combination with one another. For example, in embodiments of the invention, the contaminate levels of the recirculation loop 118 alone may be monitored. Also consistent with embodiments of the invention, the contaminate levels of the permeate water alone may be monitored. Still consistent with embodiments of the invention, both the contaminate levels of the recirculation loop 118 and the permeate water may be monitored.

For example, permeate water with too low a contaminate level can be corrosive to pipes. If the contaminate level in the permeate water is below an acceptable level, sensor 136 may instruct valve 128 to partially and/or completely close, retarding and/or halting the bleeding of contaminates.

As a safety precaution, the system 100 may also include a pressure control valve 138. Should the pressure within the system 100 become too great, valve 138 would reduce pressure by discharging water to a drain. Consistent with embodiments of the invention, multiple pressure control valves may be placed throughout the system for safety.

The system 100 may also include various other sensors, metering devices, or safety devices including but not limited to a flow meter 140, differential pressure switches 142, and filter 144. After treatment, the permeate water exits the system 100 at a point of exit 146.

During the water treatment cycle, contaminates can precipitate out of the influent water on the membrane surface. FIG. 2 depicts an embodiment of the present invention configured to clean the membranes 120. As symbolized by the “X”, valve 110 is configured to hinder and/or prohibit water from filter 106 entering pump 114. Instead, permeate water from storage tank 134 enters pump 114. Permeate water then enters the recirculation loop 118. As with the treatment cycle, the direction of flow within the recirculation loop 118 is controlled by check valve 124. While within the recirculation loop 118 pump 122 causes the water to circulate through membranes 120.

In an embodiment of the present invention, sensor 126 may be located within recirculation loop 118. By placing sensor 126 in the recirculation loop 118, the contaminate level may be monitored. Permeate water introduced into the recirculation loop 118 acts to clean the membranes and remove precipitate material or other solids from the system 100. As the permeate water circulates within the recirculation loop 118, the contaminate level may rise. Upon detection that the contaminate level has reached a maximum, sensor 126 may open valve 128 to begin flushing contaminates from the recirculation loop 118 and/or the system 100.

During cleaning of the membranes 120, permeate water may continue to be introduced and circulated within the recirculation loop 118. Sensor 126 may monitor contaminate levels within the recirculation loop 118. After a certain amount of time and/or when sensor 126 detects that the contaminate level has reached a minimum contaminate level, sensor 126 may close valve 128 to retard and/or stop the bleeding of contaminates.

During treatment of influent water, it is contemplated that sensor 126 and/or 136 may detect that the system 100 has attained a maximum contaminate level within the permeate water and/or the recirculation loop 118. Either sensor 126 and/or 136 may be configured to alter the state of valve 110 from the state shown in FIG. 1 to the state shown in FIG. 2. Permeate water may be introduced into the recirculation loop 118 from the storage tank 134. The permeate water may circulate for a predetermined time or until sensor 126 detects the contaminate level has reached a constant or has reached a maximum contaminate level. Upon reaching a maximum contaminate level, sensor 126 may open valve 128 to begin flushing contaminates from the recirculation loop 118.

This cycle of introducing and recirculating permeate water and flushing the permeate water when a certain contaminate level is reached may be repeated until the sustained contaminate level is at or below a preset contamination level. For example, if the minimum sustained contaminate level is 1,000 ppm, the introduction of permeate water and flushing of contaminates may repeat until the sustained contaminate level in the recirculation loop 118 is at or below 1,000 ppm. After which, sensors 126 and/or 136 may alter the configuration of valve 110 to allow influent water into the system 100 and halt introduction of permeate water.

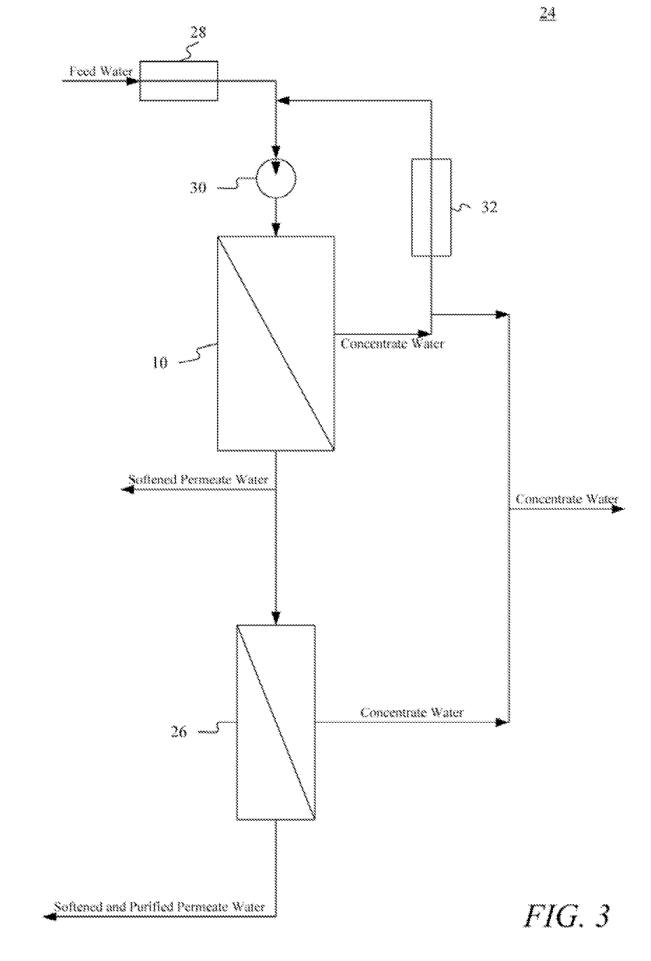

FIG. 3 shows a softening membrane in a system 24 for conditioning water according to embodiments of the present invention. In addition to the softening membrane 10, the water conditioning system 24 comprises a purification device 26 connected in series to the softening membrane 10. The purification device 26 may be configured to remove additional impurities from a portion of the output flow of softened permeate water generated from the softening membrane 10. As used herein, impurities removed by the purification device 26 may include minerals, contaminants (e.g., radon, radium, arsenic, chloramine, dissolve iron, metals, sodium), additional hardness, and bacteria (e.g. viruses, giardia, crypotosporidium). The purification device 26 may also be configured to discharge an output flow of second concentrate water. Consistent with embodiments of the present invention, the purification device 26 may comprise a membrane such as a demineralizing membrane like a “tight” reverse osmosis membrane or a loose reverse osmosis membrane. A “tight” reverse osmosis membrane differs from the loose reverse osmosis in that it may reject monovalent ionic contaminants to a higher degree. The tight reverse osmosis membrane may result in demineralized water while the loose reverse osmosis membrane may result in partially demineralized water. In addition, the purification device 26 may comprise a filter such as an activated carbon filter for the removal of chlorine, sulfides, and other taste and odor sources.

Regardless of whether a tight or loose reverse osmosis membrane is selected, the purification device may operate by taking the softened water from the softening membrane at the existing pressure and purifying it further to become purer water at the point of use, such as the refrigerator ice water dispenser, the kitchen sink or the bathroom sink, places where lower flow rates are typically needed. The rejected concentrated stream may be sent directly to the nearby drain or sewer line.

Although FIG. 3 shows that the softening membrane 10 and the purification device 26 as separate elements, it is contemplated that one membrane can perform both softening and purification functions. A high flux, chlorine resistant loose reverse osmosis membrane is one example of a membrane that can perform both softening and purification. The loose reverse osmosis membrane may perform both softening and purification by removing hardness ions as well as reducing bacteria, sodium, fluoride, arsenic, lead and other metal ions that are potentially toxic in higher concentrations.

Also, it is further contemplated that there are other possible configurations for the system shown in FIG. 3. For instance, it may be desirable to have the softening membrane 10 and the purification device 26 aligned in parallel as opposed to a serial connection so that not all the water flow has to be conditioned to the same extent and blending streams of different water qualities is desirable. Also, module size and shape could be different between the softening membrane 10 and the purification device 26.

FIG. 3 also shows that the water conditioning system 24 further comprises a prefilter 28 that filters particulates of a specified diameter from the feed water. Examples of particulates that the prefilter 28 may remove comprise elements such as bacteria, protozoa, and other microorganisms. In addition, the prefilter may remove sediments of a specified diameter and other items such as iron and chlorine. In embodiments of the invention, the prefilter 24 may comprise a carbon filter, ceramic filter, or a UV disinfecting device. FIG. 3 shows the water conditioning system 24 only with one prefilter, however, it is contemplated that more than one prefilters may be used. For example, one or more filters can act as a prefilter and one or more other filters can acts as a polishing filter.

A pump 30 may receive the filtered water and may boost the pressure. The amount of pressure boost may depend on whether the source of the feed water is a pressurized municipal supply, groundwater or well water. Typically, water pressure from one of these sources will be in the range of about 20 to about 120 pounds per square inch. The pump 30 may then boost the water pressure to a pressure that is greater than 20 pounds per square inch in order to maintain optimal performance of the softening membrane 10 and purification device 26.

FIG. 3 shows that a portion of the concentrate water generated from the softening membrane 10 is recycled back through the membrane. In particular, this portion of concentrate water may pass through a filter 32 which may capture any incipient scale produced during idle, maintenance or cleaning periods or bacterial film which may keep the softening membrane cleaner. Although FIG. 3 shows only one filter 32, the water conditioning system 24 may have more than one filter. In this embodiment, the filter 32 may comprise filters such as ceramic filters and strainers.

The water conditioning system 24 in FIG. 3 may operate by receiving the feed water provided from a water source. The prefilter 28 may filter particulates from the feed water such as bacteria, protozoa, and other microorganisms, as well as other items such as sediments (e.g., total suspended solids), iron and chlorine. The pump 30 may receive the filtered water and may boost the pressure of the water to a pressure that is greater than 20 pounds per square inch. The feed water may enter the softening membrane 10, where it may be exposed to the surface of the membrane elements. A portion may be caused to pass through the membranes and into the permeate collection material. The retained uncharged components, divalent and multivalent ions may be removed from the membrane as concentrate flow. A portion of the softened permeate water may be ready for use and consumption, while another portion of permeate may enter the purification device 26 for additional removal of impurities. The purification device 26 may generate softened and purified permeate water and may discharge an output flow of concentrate water. A portion of the concentrate from the softening membrane 10 may be recycled back to the membrane through the filter 32 and pump 30. The rest of the concentrate water from the softening membrane 10 and purification deice 26 may be discharged into a sewer along with the concentrate from the purification device 26.

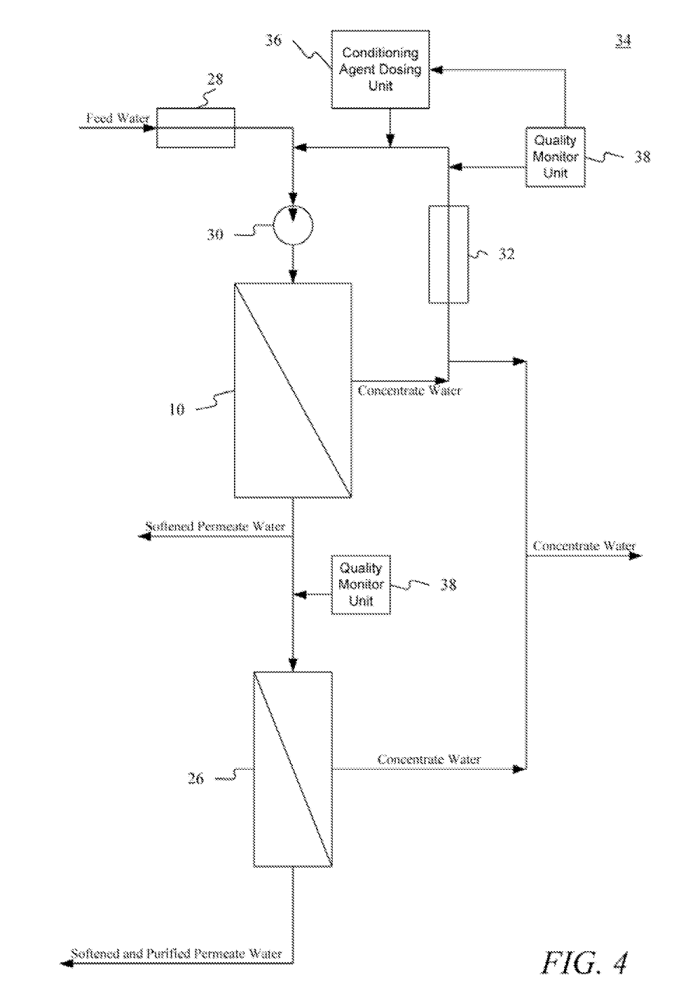

FIG. 4 is another embodiment showing the softening membrane 10 in a second system 34 for conditioning water. The second water conditioning system 34 may be similar to the one shown in FIG. 3, except that the system 34 may include a conditioning agent dosing unit 36 configured to supply at least one conditioning agent to the feed water in order to prevent membrane fouling. Antiscalants may be used to prevent scale formation in industrial systems or processes when hard water is concentrated. EDTA (ehtylenediaminetetracetic acid) and its derivatives is one type of antiscalant that has been used in these industrial applications.

Consistent with embodiments of the present invention, the at least one conditioning agent may comprise one of a scale inhibitor, an antiscalant, a biofoulant suppressant, a pH adjustment chemical additive or combinations thereof. The at least one conditioning agent may also comprise a membrane cleansing agent. All of these conditioning agents may be approved by the National Sanitation Foundation (NSF) and may be suitable for drinking and cooking.

The scale inhibitor agent, antiscalant (chelating) agent, pH adjustment chemical additive and membrane cleansing agent that may be provided by the conditioning agent dosing unit 36 may be suitable for preventing scale formation and the need for cleaning of the softening membrane 10. These agents may be useful because at some point the solubility limit of the softening membrane 10 is exceeded, causing salts to precipitate in the membrane elements. The precipitation of salts deposits or adheres to the membrane elements as a scale causing them to eventually clog. An illustrative but non-exhaustive list of scale inhibitor agents, antiscalant agents and membrane cleansing agents may include calcium carbonate antiscalants, phosphonates, biocarbonate, barium sulphate, hydrochloric acid, sulphuric acid and biostatic agents such as benzoic acids, to prevent chlorine degradation.

The biofoulant suppressants that may be provided by the conditioning agent dosing unit 36 may be suitable for reducing membrane fouling that generally arises from the formation of bacteria such as planktonic and sessile bacteria. An illustrative but non-exhaustive list of biofoulant suppressants may include biocides such as sodium metabisulfite (“sulfites”), and benzoates.

The water conditioning agents may work in the softening membrane 10 by dissolving, flushing or displacing the feed/concentrate in the lumens of the membrane elements until a substantial part of the volume of the lumens of the elements are clean. With clean membrane elements, high water fluxes across the softening membrane may be maintained. Effluent of this operation may be removed from the softening membrane 10 as concentrate and may be sent to the sewer.

Consistent with aspects of the invention, the conditioning agent dosing unit 36 may comprise a container or containers that store the conditioning agents and a device to supply the conditioning agents to the feed water such as a valve like a solenoid valve. Other configurations may include a mechanical feeder that doses a desired amount of the agent(s) to the feed water through a valve. A micro fluidic module such as a MEMS type dispenser in cooperation with a meter may supply the conditioning agent(s) to the feed water. These examples are illustrative of only few types of devices that can serve as the conditioning agent dosing unit, it is contemplated that other configurations exist.

Referring back to FIG. 4, the water conditioning system 34 may also comprises a water quality monitoring unit 38 configured to monitor the water quality of the output flow of softened permeate water. In particular, the water quality monitoring unit 38 may monitor the softened permeate water via measurements of turbidity, refractive index, conductivity, pressure, flow and the like. These measurements are illustrative of some measurements that the water quality monitoring unit 38 may take and is not exhaustive. For example, it is contemplated that the water quality monitoring unit may take measurements such as −pH, turbidity, hardness, total dissolved solids (TDS), chlorine and sulfides. Consistent with aspects of the invention, the water quality monitoring unit 38 may comprise devices such as a turbidity meter, an ion selective probe and a conductivity meter.

The water conditioning system in FIG. 4 may also include another water quality monitoring unit 38 configured to monitor the water quality of the portion of concentrate water recycled back through the softening membrane 10. The water quality monitoring unit 38 may monitor the concentrate for fouling, scaling and incipient nucleation of crystals that form scaling. The water quality monitoring unit 38 may comprise a control unit configured to control the supply of the at least one conditioning agent to the input flow of water in accordance with the monitored water quality. The water quality monitoring unit 38 is not limited to this configuration and as an alternative that unit may include an in-situ monitoring device that may be placed near the membrane 10 so that it may track scale formation right at the membrane surface.

The water conditioning system 34 in FIG. 4 may operate by receiving the feed water provided from a water source. The prefilter 28 may filter particulates from the feed water such as bacteria, protozoa, and other microorganisms, as well as other items such as sediments, iron and chlorine. The pump 30 may receive the filtered water and may boost the pressure of the water to a pressure that is greater than 20 pounds per square inch. The feed water may enter the softening membrane 10, where it may be exposed to the surface of the membrane elements. A portion may be caused to pass through the membranes and into the permeate collection material. The retained uncharged components, divalent and multivalent ions may be removed from the membrane as concentrate flow. A portion of the concentrate from the softening membrane 10 may be recycled back to the membrane through the filter 32 and pump 30. As the water may be recycled back, the water quality monitoring unit 38 may monitor the water for fouling, scaling and incipient nucleation of crystals that form scaling. The water quality monitoring unit 38 may provide a signal to control of supply conditioning agent(s) by the conditioning agent dosing unit 36 in accordance with the monitored water quality. The conditioning agent dosing unit 36 may then supply the conditioning agent(s) to the water which may flow back into the softening membrane 10. During normal operation, the conditioning agent dosing unit 36 may supply the conditioning agent(s) continuously or periodically to maintain proper operation of the membrane (e.g., prevent scale formation). During idle or off-line time, the conditioning agent dosing unit 36 may supply the conditioning agent to dissolve, flush, rinse or dislodge any deposits that have accumulated on the membrane. Concentrate water that is not recycled backed to the softening membrane 10 may be discharged into the sewer.

A portion of the softened permeate water may be ready for use and consumption, while another portion of permeate may enter the purification device 26 for removal of impurities. As the water enters the purification device 26, the water quality monitoring unit 38 may monitor the water quality of the output flow of softened permeate water. In particular, the water quality monitoring unit 38 may monitor the softened permeate water via measurements of turbidity, refractive index, conductivity, pressure, flow and the like. The purification device 26 may then generate softened and purified permeate water and may discharge an output flow of concentrate water, which may be discharged into the sewer.

Although the water conditioning systems shown in FIGS. 3-4 may be point-of-entry systems, it is possible to configure them as point-of-use systems. For example, the softening membrane 10, possibly located in bathrooms, may be configured to prevent residue build-up around sinks and tubs and near dishwashers to prevent build-up on dishes and utensils. Also, the softening membrane 10, possibly located near a washing machine, may be configured to prevent water deposits from forming on clothing. The purification device may then be located in the kitchen and it may be used for drinking and culinary applications.

It may be desirable to run feed water or even softened water through the membrane for a few seconds or a minute longer at prevailing (low pressure) city water pressure to displace the high concentration concentrate stream from the membrane lumens. Generally, when a demand for water has ended in a house, it is typical for the membrane module to be left with high hardness concentrate water on the concentrate side of the membrane. Under these circumstances, where the concentrate hardness may be above the saturation limit of the salts present in the water, it is likely that the hardness salts may precipitate onto the membrane causing it to foul and form scale. To help avoid the precipitation of hardness salts over time, it would be desirable to run feed water or softened water through the membrane for a few seconds or a minute longer at prevailing (low pressure) city water pressure to displace the high concentration concentrate stream from the membrane lumens and aid further in the dissolution of any previous hardness scale that might have previously formed or break ion concentration polarization or other contaminants that accumulate within the lumens.

This flushing process may be done automatically at the end of every water demand cycle, or periodically after a few hours of idle time. In this way, scale may be prevented from forming and clogging the membrane over time during idle operation. The flushing water may be sent to the drain or sewer or to the discharge location for the concentrate. Furthermore, since most feed city waters are below their saturation level with respect to hardness, this state of flushing the membrane may foster the dissolution of any scale that might have formed and lodged within the membrane and may help restore some of the initial higher flux. Additional benefits of this flushing method include breaking the ion concentration polarization, dislodging bacteria or debris, or other ions present.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method for treating water, the method comprising:
circulating influent water in a recirculation loop, wherein a substantial portion of the influent water passes through at least one membrane;
monitoring a recirculation contaminate level in the recirculation loop; and
when the recirculation contaminate level exceeds a maximum contaminate level, bleeding contaminates from the recirculation loop.

2. The method of claim 1 further comprising retarding the bleeding of contaminates from the recirculation loop when the recirculation contaminate level is below a minimum recirculation contaminate level.

3. The method of claim 2 wherein the minimum recirculation contaminate level is about 1,000 parts per million.

4. The method of claim 1 further comprising stopping the bleeding of contaminates from the recirculation loop when the recirculation contaminate level is below a minimum recirculation contaminate lever.

5. The method of claim 1 further comprising:
monitoring a permeate contaminate level in permeate water, wherein monitoring the permeate contaminate level occurs after permeate water has exited the recirculation loop; and
when the permeate contaminate level is below a minimum permeate contaminate level, overriding the bleeding of contaminates from the recirculation loop so that bleeding is retarded.

6. The method of claim 1 wherein the maximum recirculation contaminate level is about 1,500 parts per million.

7. The method of claim 1 further comprising:
monitoring a permeate contaminate level, wherein monitoring the permeate contaminate level occurs after permeate water has exited the recirculation loop; and
when the permeate contaminate level is below a minimum permeate contaminate level, overriding the bleeding of contaminates from the recirculation loop so that bleeding is stopped.

8. A method for treating water, the method comprising:
circulating influent water in a recirculation loop, wherein a substantial portion of the influent water passes through at least one membrane;
monitoring a permeate contaminate level, wherein monitoring the permeate level occurs after permeate has exited the recirculation loop; and
when the permeate contaminate level exceeds a maximum permeate contaminate level bleeding contaminates from the recirculation loop.

9. The method of claim 8 further comprising when the permeate contaminate level is below a minimum permeate contaminate level, retarding the bleeding of contaminates from the recirculation loop.

10. The method of claim 8 further comprising when the permeate contaminate level is below a minimum permeate contaminate lever, stopping the bleeding of contaminates from the recirculation loop.

11. The method of claim 10 wherein the minimum permeate contaminate level is about 30 parts per million.

12. The method of claim 8 further comprising:
monitoring a recirculation contaminate level, wherein monitoring the recirculation contaminate level within the recirculation loop; and
when the recirculation contaminate level is below a minimum recirculation contaminate level, overriding the bleeding of contaminates from the recirculation loop so that bleeding is retarded.

13. The method of claim 8 wherein the maximum permeate contaminate level is about 120 parts per million.

14. The method of claim 8 further comprising:
monitoring a recirculation contaminate level, wherein monitoring the recirculation contaminate level occurs within the recirculation loop; and
when the recirculation contaminate level is below a minimum recirculation contaminate level, overriding the bleeding of contaminates from the recirculation loop so that bleeding is stopped.

15. A system for treating water, the system comprising:
a recirculation loop configured to allow a substantial portion of influent water to pass through at least one membrane;
a first sensor configured to monitor a first contaminate level within the system; and
a bleeding system operatively connected to the first sensor, wherein the bleeding system is configured to bleed contaminates from the system upon receiving an indication from the first sensor.

16. The system of claim 15 wherein the first contaminate level is a recirculation contaminate level.

17. The system of claim 15 wherein the first contaminate level is a permeate contaminate level.

18. The system of claim 15 further comprising:
a storage reservoir for storing a membrane cleaning fluid; and
a valve to halt influent water from entering the system,
wherein the recirculation pump configured to circulate the membrane cleaning fluid through the recirculation loop so as to clean at least one membrane.

19. The system of claim 18 wherein the membrane cleaning fluids is water.

20. The system of claim 15 further comprising a second sensor configured to monitor a second contaminate level, where the first contaminate level is a recirculation contaminate level and the second contaminate level is a permeate contaminate level.

21. A pumping system comprising:
a pump having an inlet and a discharge;
a flow loop connecting the inlet and the discharge, the flow loop having a beginning and an end; and
a throttling device configured to control a race state of the pump, wherein controlling the race state comprises causing a pressure drop in the flow loop so that the pressure at the end of the recirculation loop has a pressure substantially equal to that of the inlet of the pump.

22. The system of claim 21 wherein the throttling device comprises a pressure control valve.

23. The system of claim 21 wherein the throttling device is a differential pressure control valve.

24. The system of claim 21 wherein the pump is a non-variable pump.

25. The system of claim 21 wherein the pump is a variable pump.

26. The system of claim 21 wherein the pump is a rotary vane pump.

26. A method for controlling a pressure increase of a pump, the pump having an inlet and an exit, the method comprising:
utilizing a flow loop connecting the inlet and the exit, wherein the flow loop includes a throttling device; and
controlling a race state of the pump by adjusting the throttling device to divert a portion of fluid exiting the pump into the flow loop.

27. The method of claim 26 wherein the pump is a non-variable pump.

28. The method of claim 26 wherein the pump is a variable pump.

29. The method of claim 26 wherein the pump is a rotary vane pump.

30. The method of claim 26 wherein the throttling device is a pressure control valve.

31. The method of claim 26 wherein the throttling device is a differential pressure control valve.
